(19) United States
(12) Patent Application Publication
(10) Pub. No.: US 2020/0012273 A1
(43) Pub. Date: Jan. 9, 2020

(54) COMMUNICATION ROBOT AND METHOD FOR OPERATING THE SAME

(71) Applicant: LG ELECTRONICS INC., Seoul (KR)

(72) Inventor: Sul Ran Kim, Seoul (KR)

(73) Assignee: LG ELECTRONICS INC., Seoul (KR)

(21) Appl. No.: 16/571,998

(22) Filed: Sep. 16, 2019

(30) Foreign Application Priority Data
Jun. 18, 2019 (KR) 10-2019-0072328

(51) Int. Cl. G05D 1/00; G06F 3/16

(52) U.S. Cl. CPC G05D 1/0016; H04L 67/12; G05D 1/0022; G06F 3/165

(57) ABSTRACT

A communication robot for controlling an output device by performing an artificial intelligence (AI) algorithm and/or a machine learning algorithm in a 5G communication environment for Internet of Things (IoT), and a method for driving the same, are disclosed. Accordingly, the communication robot may control an output device based on a result of searching for at one or more output devices disposed in the given space and an operation mode of the communication robot, resulting in enhanced performance of the communication robot.

### CROSS-REFERENCE TO RELATED APPLICATION

The present application claims benefit of priority to Korean Patent Application No. 10-2019-0072328, entitled “Communication robot and method for operating the same,” filed on Jun. 18, 2019 in the Korean Intellectual Property Office, the entirety of which is incorporated by reference herein.

### BACKGROUND

### 1. Field of the Invention

The present disclosure relates to a communication robot and a method for driving the same. More particularly, the present disclosure relates to a communication robot configured to control operation of one or more output device disposed in a given space and which output audio data and/or video data, in response to a result of searching for at least one output device and an operation mode of the communication robot, and a method for driving the communication robot.

### 2. Description of Related Art

Robots have been developed for industrial use, and play a role in factory automation. Recently, application fields of robots are rapidly increasing. For example, various types of robots, such as medical robots and spacecraft robots, are being used. In addition, household robots for use in ordinary households are also being developed.

Korean Patent Application Publication No. 10-2014-0004509 (hereinafter referred to as “Related Art 1”) discloses a technology for switching an output source from a mobile terminal to a Bluetooth® device, when the mobile terminal is connected to the Bluetooth® device.

Korean Patent Application Publication No. 10-2016-0148380 (hereinafter referred to as “Related Art 2”) discloses a technology for switching image signal information from a mobile terminal to a display device, when the mobile terminal is connected to the display device.

However, although the technologies disclosed in Related Art 1 and Related Art 2 are capable of simply switching output audio signals or image signals to be outputted by a wirelessly connected external device, they are unable to control one or more output devices in a customized manner according to various situations encountered in a specific space.

The related art described above refers to technical information possessed or acquired by the inventor(s) of the present disclosure, and are not to be considered as technology well known to the public prior to the filing of the present disclosure.

### SUMMARY OF THE INVENTION

The present disclosure is directed to providing a technology for controlling an output device based on the result of searching for one or more output devices disposed in a given space and an operation mode of the communication robot, so as to enhance performance of the communication robot.

The present disclosure is further directed to providing a technology for allowing a communication robot to adjust the volume of a nearby output device that is interfering with a video call or a voice call being made, so that the call can be made in a quiet environment.

The present disclosure is still further directed to providing a technology for allowing a communication robot to adjust the volume of a nearby output device that is interfering with content being played back, so that a call can be made in a quiet environment.

The present disclosure is yet further directed to providing a technology for allowing a communication robot to select one or more output devices when a video call or a voice call is made, and output video or audio signals through the selected output device, so that the video or audio signals can be reproduced through the selected output device under optimum conditions.

The present disclosure is still yet further directed to providing a technology for allowing a communication robot to select one or more output devices when content is played back, and output at least one among a video signal and an audio signal through the selected output device, so that the signals can be reproduced through the selected output device under optimum conditions.

The present disclosure is not limited to what has been described above, and other aspects, which are not mentioned, may be clearly understood by those skilled in the art from the description below.

Additional advantages, aspects, and features of the invention will be set forth in part in the description which follows and in part will become apparent to those having ordinary skill in the art upon examination of the following or may be learned from practice of the invention. These and other advantages of the invention may be realized and attained by the structure particularly pointed out in the written description and claims hereof as well as the appended drawings.

A method for driving a communication robot according to an embodiment of the present disclosure may include controlling an operation of an output device which is disposed in a given space, based on the result of searching for one or more output devices disposed in the given space and an operation mode of the communication robot.

In more detail, the method for driving the communication robot according to this embodiment may include searching for one or more output devices which are disposed in the space and which are outputting at least one among an audio signal and a video signal, and adjusting an output signal of the searched output device in response to an operation mode of the communication robot.

Through the method for driving the communication robot according to this embodiment, the operation of an output device disposed in the given space may be controlled based on the result of searching for one or more output devices in the given space and an operation mode of the communication robot. Accordingly, performance of the communication robot may be enhanced.

The method for driving the communication robot may further include, after completion of the searching for the one or more output devices, calculating at least one among position information of the communication robot and position information of the output device.

The adjusting the output signal of the output device may include adjusting an output signal of the output device spaced apart from the communication robot by a predetermined distance or less.

The method for driving the communication robot may further include, after completion of the searching for the one or more output devices, selecting at least one of the one or more searched output devices in response to an operation mode of the communication robot, and transmitting, to the selected output device, at least one among an audio signal and a video signal that are being outputted by the communication robot.

The selecting at least one of the one or more searched output devices may include selecting an output device corresponding to predefined priority information from among the one or more searched output devices, in response to the operation mode of the communication robot.

The selecting at least one of the one or more searched output devices may include selecting an output device from among the one or more searched output devices having better performance information, in response to the operation mode of the communication robot.

The selecting at least one of the one or more searched output devices may include selecting an output device spaced apart from the communication robot by a predetermined distance or less, in response to the operation mode of the communication robot.

Through the method for driving the communication robot according this embodiment, using the communication robot, the volume of a nearby output device that interferes with a video call or a voice call being made may be adjusted so that the call may be made in a quiet environment, thereby improving satisfaction of the user who uses the communication robot. In addition, using the communication robot, the volume of a nearby output device that interferes with content being played back may be adjusted so that the call may made in a quiet environment, thereby improving satisfaction of the user who uses the communication robot.

Through the method for driving the communication robot, using the communication robot, at least one output device may be selected when a video call or a voice call is made, and video or audio signals may be reproduced by the selected output device under optimum conditions, thereby improving satisfaction of the user who uses the communication robot. In addition, using the communication robot, an output device may be selected according to a type of content when content is played back, and audio signals may be reproduced through the selected output device under optimum conditions, thereby improving satisfaction of the user who uses the communication robot.

A communication robot according to another embodiment of the present disclosure may include a searcher configured to search for one or more output devices which are disposed in a given space and which are outputting at least one among an audio signal and a video signal, and an adjuster configured to adjust an output signal of the searched output device in response to an operation mode of the communication robot.

The communication robot according to this embodiment may control operation of the output device disposed in the space based on the result of searching for one or more output devices disposed in the given space and on an operation mode of the communication robot. Accordingly, performance of the communication robot may be enhanced.

The communication robot may further include a calculator configured to calculate at least one among position information of the communication robot and position information of the output device, after completion of the searching by the searcher.

The adjuster may adjust an output signal of the output device that is spaced apart from the communication robot by a predetermined distance or less.

The communication robot may further include a selector configured to, after completion of the searching by the searcher, select at least one of the one or more searched output devices in response to an operation mode of the communication robot, and transmit, to the selected output device, at least one among an audio signal and a video signal that are being outputted by the communication robot.

In addition, the selector may select an output device corresponding to predefined priority information from among the one or more searched output devices, in response to the operation mode of the communication robot.

Further, the selector may select an output device from among the one or more searched output devices having better performance information, in response to the operation mode of the communication robot.

Furthermore, the adjuster may reduce an output volume of the output device in response to a call mode of the communication robot.

In addition, the selector may select an output device appropriate to a type of content to be reproduced, in response to a content playback mode of the communication robot.

Through the method for driving the communication robot according to an embodiment described above, using the communication robot, at least one output device may be selected when a video call or a voice call is made, and video or audio signals may be reproduced by the selected output device under optimum conditions, thereby improving satisfaction of the user who uses the communication robot. In addition, using the communication robot, an output device may be selected according to a type of content when content is played back, and audio signals may be reproduced through the selected output device under optimum conditions, thereby improving satisfaction of the user who uses the communication robot.

In addition, another method and another system for implementing the present disclosure, and a computer program for executing the method, may also be provided.

The present disclosure is not limited to what has been described above, and other aspects, which are not mentioned, may be clearly understood by those skilled in the art from the description below.

According to embodiments of the present disclosure, by controlling operation of the output device based on the result of searching for at least one output device disposed in a given space and on an operation mode of the communication robot, performance of the communication robot may be improved.

In addition, using the communication robot, the volume of a nearby output device that is interfering with a video call or a voice call being made may be adjusted so that the call may be made in a quiet environment, thereby improving satisfaction of the user who uses the communication robot

In addition, using the communication robot, the volume of a nearby output device that interferes with content being played back may be adjusted so that the call may made in a quiet environment, thereby improving satisfaction of the user who uses the communication robot.

In addition, using the communication robot, at least one output device may be selected when a video call or a voice call is made, and video or audio signals may be reproduced by the selected output device under optimum conditions, thereby improving satisfaction of the user who uses the communication robot.

In addition, using the communication robot, an output device may be selected according to a type of content when content is played back, and an audio signal may be reproduced by the selected output device under optimum conditions, thereby improving satisfaction of the user who uses the communication robot.

In addition, although the communication robot is a mass-produced and standardized product, since the user may perceive the communication robot as a personalized device, the effects associated with user-customized products may be provided to the user.

The present disclosure is not limited to what has been described above, and other effects, which are not mentioned, may be clearly understood by those skilled in the art from the description below.

### BRIEF DESCRIPTION OF DRAWINGS

The foregoing and other aspects, features, and advantages of the invention, as well as the following detailed description of the embodiments, will be better understood when read in conjunction with the accompanying drawings. For the purpose of illustrating the present disclosure, there is shown in the drawings an exemplary embodiment, it being understood, however, that the present disclosure is not intended to be limited to the details shown because various modifications and structural changes may be made therein without departing from the spirit of the present disclosure and within the scope and range of equivalents of the claims. The use of the same reference numerals or symbols in different drawings indicates similar or identical items.

FIG. 1 is a conceptual diagram illustrating a communication robot driving environment including a communication robot, an output device, a user terminal, a server, and a network for connecting the above elements, according to an embodiment of the present disclosure.

FIGS. 2 and 3 are views illustrating an external appearance of a communication robot according to an embodiment of the present disclosure.

FIG. 4 is a block diagram illustrating a communication robot according to an embodiment of the present disclosure.

FIGS. 5A, 5B and 6 are conceptual diagrams illustrating a method for driving a communication robot according to an embodiment of the present disclosure.

FIGS. 7 and 8 are flowcharts illustrating a method for driving a communication robot according to an embodiment of the present disclosure.

### DETAILED DESCRIPTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated.

In general, the terms “module” and “unit” may be used to refer to elements or components. Use of such terms herein is merely intended to facilitate description of the specification, and the terms themselves is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

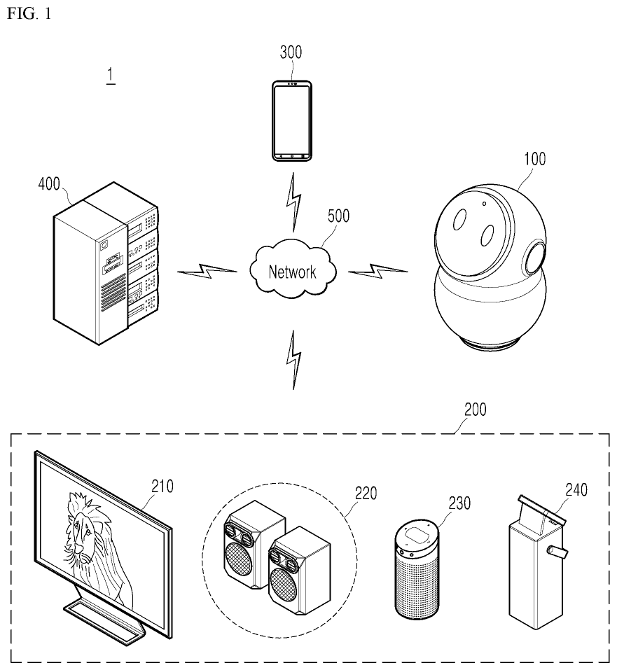

FIG. 1 is a conceptual diagram illustrating a communication robot driving environment including a communication robot, an output device, user terminal, a server, and a network for connecting the above elements, according to an embodiment of the present disclosure. Referring to FIG. 1, a communication robot driving environment 1 may include a communication robot 100, an output device 200, user terminal 300, a server 400, and a network 500.

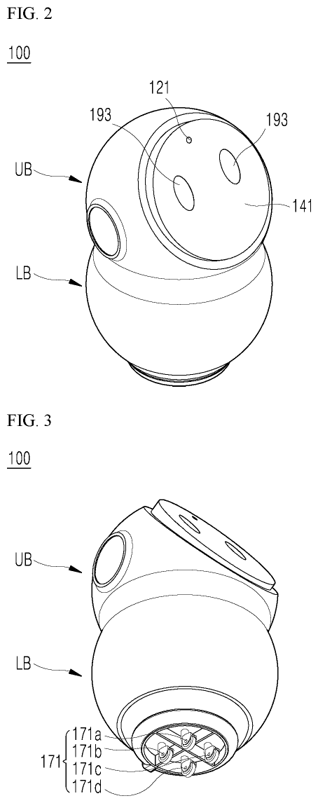

The communication robot 100 may communicate with a user through emotional interactions such as eye contact, emotional expression, and touch. When the user strokes an upper body UB of the communication robot 100, or when the communication robot 100 receives a voice input of the user, the communication robot 100 may display various expressions, such as joy, sadness, anger, and calmness, through eyes (193 in FIG. 2) thereof. In addition, the communication robot 100 may reproduce various contents, may provide a variety of information (such as weather information, navigation information, and fortune telling information), and may also remotely control various home appliances through the network 500.

In this case, “content” or “contents” may include digital information and individual information elements that can be accessed through the network 500, examples of which may include characters, symbols, voice, sound, sound sources, images, and moving images (including video and audio data). The content or contents may include data such as text data, image data, moving image data, sound source data, and link data (such as a web link), or a combination of at least two types of data among the above data.

The communication robot 100 according to this embodiment may be provided in a given space (such as a home, a company, or a hospital), may search for one or more output devices 200 which are disposed in the same space as the communication robot 100 and which are outputting at least one among an audio signal and a video signal, and may adjust an output signal of the one or more searched output devices 200 in response to an operation mode of the communication robot 100. Here, examples of the operation modes of the communication robot 100 may include a call mode (voice call or video call) made in conjunction with the user terminal 300, and a content playback mode for playing back content. In addition, adjustment of the output signal of the output device 200 may include a process for adjusting the volume of an audio signal being outputted by the output device 200.

In addition, the communication robot 100 may select at least one of the one or more searched output devices 200 in response to the operation mode of the communication robot 100, and may transmit, to the selected output device 200, at least one among an audio signal and a video signal.

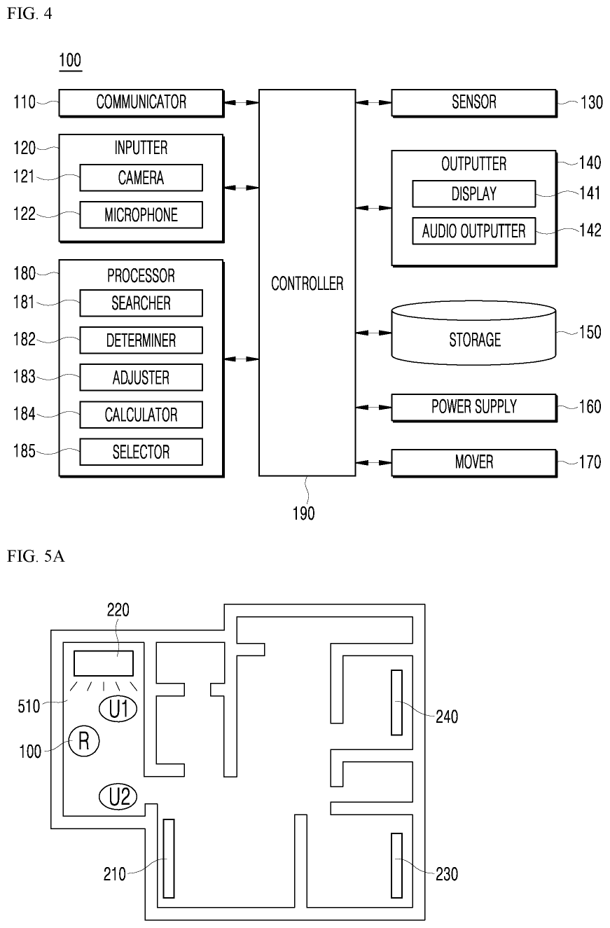

In this case, the selecting of the output device 200 may include, during a call mode for performing a call between a user and a caller through a display (141 in FIG. 4) and an audio outputter (142 in FIG. 4) of the communication robot 100, selecting any one output device 200 to be used to output information of the caller (such as an image, a name, and a phone number of the caller), selecting any one output device 200 to be used to output the voice of the caller (an audio signal), and/or selecting any one output device 200 to be used to output information of the caller and the voice of the caller.

In addition, the selecting of the output device 200 may include, during a playback mode for reproducing user-selected content through the display (141 in FIG. 4) and the audio outputter (142 in FIG. 4) of the communication robot 100, selecting any one output device 200 to be used to output a video signal contained in the content, selecting any one output device 200 to be used to output an audio signal contained in the content, and/or selecting any one output device 200 to be used to output the video signal and the audio signal contained in the content.

The output devices 200 may be electronic devices capable of outputting at least one among audio signals and video signals. Examples of the output devices 200 may include a television (TV) 210, a two-channel speaker 220, an artificial intelligence (AI) speaker 230, a beam projector, and an embedded speaker (such as an audio outputter 142 in FIG. 4). Although the output devices 200 in the present disclosure have been defined as the above-mentioned electronic devices, the present disclosure is not limited thereto, and the output devices 200 may further include various home appliances, such as a washing machine, an air conditioner, a refrigerator, and a cleaner.

At least one of the output devices 200 may receive a control signal including a function of adjusting an output signal from the communication robot 100, and may thereby adjust the output volume of the audio signal to be higher or lower than a current volume, or to be turned off.

In addition, at least one of the output devices 200 may receive a request for outputting a video signal from the communication robot 100, and the output device 200 may thereby receive the video signal from the communication robot 100 and display the received video signal. In addition, at least one of the output devices 200 may receive a request for outputting an audio signal from the communication robot 100, and may thereby receive the audio signal from the communication robot 100 and output the received audio signal. Moreover, at least one of the output devices 200 may receive a request for outputting a video signal and an audio signal from the communication robot 100, and may thereby receive the video signal and the audio signal from the communication robot 100 and output the video signal and the audio signal.

The user terminal 300 may access a communication robot driving application or a communication robot driving website, and may then perform a user authentication process so as to receive a communication robot driving service or a communication robot control service. In the present embodiment, the authenticated user terminal 300 may control the communication robot 100, and may control operation of the communication robot 100.

In the present embodiment, the user terminal 300 may include various kinds of user-controllable devices, such as a desktop computer, a smartphone, a laptop, a tablet PC, a smart TV, a mobile phone, a personal digital assistant (PDA), a media player, a micro server, a global positioning system (GPS) device, an E-book terminal, a digital broadcast terminal, a navigation device, a kiosk, an MP3 player, a digital camera, home appliances, and other mobile or non-mobile computing devices, without being limited thereto. In addition, the user terminal 300 may be a wearable terminal including a communication function and a data processing function, such as a watch, glasses, a headband, and a ring. However, the user terminal 300 is not limited thereto, and all kinds of terminals capable of web-browsing may also be applied to the present disclosure. In an alternative example of the above-mentioned embodiment, the user terminal 300 may also operate as any one of the above-mentioned output devices 200.

The server 400 may be a database (DB) server for providing big data needed to use various artificial intelligence (AI) algorithms and data needed to operate the communication robot 100. Further, the server 400 may include a web server or an application server for remotely controlling an operation of the communication robot 100 using the communication robot driving application or a communication robot driving web-browser.

Here, artificial intelligence refers to an area of computer engineering science and information technology that studies methods to make computers mimic intelligent human behaviors such as reasoning, learning, self-improving, and the like.

In addition, AI does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed. More specifically, machine learning is a technology that investigates and builds systems, and algorithms for such systems, which are capable of learning, making predictions, and enhancing their own performance on the basis of experiential data. Machine learning algorithms, rather than only executing rigidly set static program commands, may take an approach that builds models for deriving predictions and decisions from inputted data.

The server 400 may receive, from the communication robot 100, the result of searching for one or more operating output devices 200 and an operation mode of the communication robot 100, and may transmit, to the communication robot 100, a control signal for adjusting an output signal of the one or more searched output devices 200 in response to the received operation mode. In addition, the server 400 may receive operation mode information of the communication robot 100 from the communication robot 100, transmit the result of selecting at least one among the one or more searched output devices 200 to the communication robot 100, and cause the communication robot 100 to output at least one among an audio signal and a video signal to the selected output device 200.

The network 500 may connect the communication robot 100, the output device 200, the user terminal 300, and the server 400. The network 500 may include a wired network such as a Local Area Network (LAN), a Wide Area Network (WAN), a Metropolitan Area Network (MAN), and an Integrated Services Digital Network (ISDN), and a wireless network such as wireless LAN, Code Division Multiple Access (CDMA), Bluetooth®, and satellite communication, without being limited thereto. In addition, the network 500 may transmit and receive information via short range communication and/or long range communication. Here, the short range communication may include Bluetooth®, Radio Frequency Identification (RFID), Infrared Data Association (IrDA), Ultra Wideband (UWB), ZigBee, and Wireless-Fidelity (Wi-Fi). The long range communication may include Code Division Multiple Access (CDMA), Frequency Division Multiple Access (FDMA), Time Division Multiple Access (TDMA), Orthogonal Frequency Division Multiple Access (OFDMA), and Single Carrier Frequency Division Multiple Access (SC-FDMA).

The network 500 may include connection of network elements, such as a hub, a bridge, a router, a switch, and a gateway. The network 500 may include a public network such as the Internet, a private network such as a secure enterprise private network, and one or more interconnected networks, such as a multiple network environment. Access to the network 500 may be provided via one or more wired or wireless access networks. Moreover, the network 500 may support Internet of Things (IoT) for enabling separate constituent elements to communicate with each other, and/or 5G communication.

FIGS. 2 and 3 are views illustrating an external appearance of a communication robot 100 according to an embodiment of the present disclosure. In the following description, description of reference numerals overlapping with those of FIG. 1 will be omitted for convenience of description.

Referring to FIGS. 2 and 3, the communication robot 100 may include an upper body UB and a lower body LB. The upper body UB may form an upper part of the body, and the lower body LB may form a lower part of the body.

The upper body UB may include a camera 121, and may thereby photograph an image of the surroundings of the communication robot 100. A controller (190 in FIG. 4) may control the camera 121. In addition, the upper body (UB) may include a display 141, and may thereby display, for example, an operation mode and/or an operation state of the communication robot 100 thereon. When the operation mode of the communication robot 100 is the call mode, the display 141 may display an image of the caller and/or information (such as a phone number and a name) of the caller. In addition, when the operation mode of the communication robot 100 is the content playback mode, the display 141 may display content and/or content information (such as source information of the content, a content provider, a title, and a playback time).

Further, the display 141 may display elliptical or circular shapes 193 similar in shape to human eyes, under control of the controller (190 in FIG. 4). In response to a user's touch or voice, the display 141 may display various expressions such as joy, sadness, anger, and calmness, through the elliptical or circular shapes 193.

The lower body LB may include a mover 170 composed of four wheels 171a to 171d, and the mover 170 may move and/or stop moving according to the operation mode and/or the operation state of the communication robot 100. The controller (190 in FIG. 4) may control the direction, movement, and/or stoppage of the four wheels 171a to 171d. In an alternative embodiment of the present disclosure, the communication robot 100 may cause the mover 170 to start operating in response to a user's gesture or voice, so as to allow the communication robot 100 to move to the vicinity of the user.

FIG. 4 is a block diagram illustrating a communication robot 100 according to an embodiment of the present disclosure. In the following description, description of reference numerals overlapping with those of FIGS. 1 to 3 will be omitted for convenience of description. Referring to FIG. 4, the communication robot 100 may include a communicator 110, an inputter 120, a sensor 130, an outputter 140, a storage 150, a power supply 160, a mover 170, a processor 180, and a controller 190.

The communicator 110 may operate in conjunction with the network 500, and may thereby provide a communication interface required for providing transmission/reception signals between the output device 200, the user terminal 300, and/or the server 400 in the form of packet data. In addition, the communicator 110 may support, for example, a variety of machine to machine (M2M) communications (such as Internet of Things (IoT), Internet of Everything (IoE), and Internet of Small Things (IoST)), machine to machine (M2M) communication, Vehicle to Everything (V2X) communication), and Device to Device (D2D) communication.

The inputter 120 may include a camera 121 for receiving input of image signals and a microphone 122 for receiving input of audio signals. Under control of the controller 190, the camera 121 may photograph an image of the surroundings of the communication robot 100 according to an operation mode and/or operation state of the communication robot 100. In order to increase efficiency of the photographing, a plurality of cameras 121 may also be provided. For example, the camera 121 may include at least one optical lens, an image sensor (for example, a CMOS image sensor) provided with a plurality of photodiodes (for example, pixels) which form an image due to light passing through the optical lens, and a digital signal processor (DSP) for constructing one or more images based on the output signals of the photodiodes. In addition to still images, the digital signal processor (DSP) may generate moving images formed by frames composed of still images. Further, the image photographed and acquired by the camera 121 may be stored in the storage 150. In the present embodiment, the camera 121 may photograph images needed to calculate the position of the communication robot 100, the position of each output device 200, and the position of the user.

Under control of the controller 190, the microphone 122 may receive input of a spoken utterance of the user. In order to more accurately receive the spoken utterance of the user, a plurality of the microphones 122 may also be used. In this case, the microphones 122 may be installed at different positions while being spaced apart from each other by a predetermined distance, and may convert the received spoken utterance of the user into an electrical signal. Here, the inputter 120 may use various noise removal algorithms to remove noise generated in the process of receiving the user voice signal. In an alternative example of the present disclosure, the inputter 120 may include various constituent elements for processing spoken utterances of the user, such as a noise removal filter (not shown) for removing noise from the received spoken utterance and an amplifier (not shown) for amplifying an output signal of the noise removal filter and outputting the amplified signal.

In an alternative example of the present disclosure, the inputter 120 may include a user inputter (not shown) (for example a touch-type key or a push-type mechanical key) for receiving information from the user, used in relation to setting of the driving mode.

For example, the inputter 120 may include first to fourth contact switches (not shown). A program pre-stored in the storage 150 may determine how output signals of the respective contact switches are to be processed. For example, left-directional menus displayable in the left direction on the display 141 or right-directional menus displayable in the right direction on the display 141 may be selected according to an operation signal of the first contact switch or an operation signal of the second contact switch. In addition, upward menus displayable in the upward direction on the display 141 or downward menus displayable in the downward direction on the display 141 may be selected according to an operation signal of the third contact switch or an operation signal of the fourth contact switch. In addition, a voice recognition function may be activated by operating any one of the first to fourth contact switches. In an alternative example of the present disclosure, the inputter 120 may further include a voice recognition module (not shown) that recognizes a spoken utterance of the user and generates a drive signal for enabling the communication robot 100 to perform a command corresponding to the recognized voice signal under control of the controller 190.

The sensor 130 may include one or more sensors for sensing at least one among internal information of the communication robot 100, surrounding environment information of the communication robot 100, and user information. For example, the sensor 130 may include at least one among an obstacle detection sensor (for example, a proximity sensor or a Light Detection And Ranging (LiDAR) sensor), a weight detection sensor, an illumination sensor, a touch sensor, an acceleration sensor, a magnetic sensor, a gravity sensor (G-sensor), a gyroscope sensor, a motion sensor, an RGB sensor, an infrared (IR) sensor, a fingerprint recognition sensor, an ultrasonic sensor, an optical sensor (for example, the camera 121), a microphone (for example, the microphone 122), a battery gauge, an environmental sensor (for example, a barometer, a hygrometer, a thermometer, a radioactivity detection sensor, a heat detection sensor, or a gas detection sensor), and a chemical sensor (for example, an electronic nose, a healthcare sensor, or a biometric sensor). In addition, the communication robot 100 of the present disclosure may combine various kinds of information sensed by at least two of the above-mentioned sensors, and may use the combined information.

The outputter 140 may output information related to operations of the communication robot 100 as, for example, visual data, auditory data, and tactile sensation data. The outputter 140 may include a display 141, an audio outputter 142, and a haptic outputter (not shown).

The display 141 may output information related to an operation of the communication robot 100 as visual data. The display 141 may form a mutual layer structure with a touch sensor, or may be formed integrally with the touch sensor, and may thereby be implemented as a touchscreen. The touchscreen may serve as a user inputter that provides an input interface between the communication robot 100 and the user, while at the same time providing an output interface between the communication robot 100 and the user.

The audio outputter 142 may output information related to the operation of the communication robot 100 as audio data, and may audibly output various notification messages (such as a warning sound, and a sound indicating, for example, an operation mode, an operation state, an error state), information corresponding to a voice command of the user, and the result of processing the voice command of the user. The audio outputter 142 may convert an electrical signal received from the controller 190 into an audio signal. For this purpose, the audio outputter 142 may include, for example, a speaker (not shown).

The storage 150 may store data to support various functions of the communication robot 100. The storage 150 may store a plurality of application programs (or applications) to be driven by the communication robot 100, data for operating the communication robot 100, and commands for the communication robot 100. At least some of the application programs may be downloaded from an external server via wireless communication. In addition, the storage 150 may store user information related to at least one user who desires to interact with the communication robot 100. The user information may be used to identify a recognized user.

In the present embodiment, the storage 150 may store map information based on which the communication robot 100 may move, performance information and/or position information of the output device 200, and user characteristic information (such as facial information and voice information of the user) for identifying the corresponding user. In the case of a specific user, the storage 150 may store an output volume to be adjusted for the specific user. Here, the performance information of the output device 200 may include output intensity information, information about the number of channels, and various types of information indicating output performance. For example, performance information of a sound output device may include information about the number of channels to be used, information on how many watts are needed for a given sound output intensity, information about the presence or absence of a specific output function (such as, for example, a woofer support function, a stereo sound support function, and a tweeter support function). Performance information of an image output device may include resolution information of a displayed image, size information (a number of inches) of a displayed image, and information about the presence or absence of a specific output function (such as, for example, information about whether a processing speed based on 5G communication is supportable and information about whether an IPTV function is supportable).

In addition, the storage 150 may store priority information of one or more output devices 200 that are capable of outputting video signals and/or audio signals in response to the operation mode of the communication robot 100. Thereafter, the communication robot 100 may select one of the output devices 200 according to the priority information stored in the storage 150. In an alternative example of the present disclosure, the priority information may be set by user selection. In addition, a wake-up word for activating the communication robot 100 may be stored in the storage 150. Accordingly, when the user utters the wake-up word, the voice recognition module may recognize the uttered wake-up word, and the communication robot 100 may transition from a deactivated state to an activated state. In addition, the storage 150 may store task information to be executed by the communication robot 100 in response to the voice command of the user (a spoken utterance for adjusting an output volume of the output device 200, or a spoken utterance for selecting at least one of the output devices 200).

In the present embodiment, the storage 150 may temporarily or permanently store data processed by the controller 190. Here, the storage 150 may include magnetic storage media or flash storage media, but the present disclosure is not limited thereto. The storage 150 may include an internal memory and/or an external memory. The storage 150 may include a volatile memory such as dynamic read-only memory (DRAM), static read-only memory (SRAM), or synchronous dynamic read-only memory (SDRAM), a non-volatile memory such as a one time programmable ROM (OTPROM), a programmable read-only memory (PROM), an erasable programmable read only memory (EPROM), an electrically erasable and programmable read only memory (EEPROM), a mask ROM, a flash ROM, a NAND flash memory, or a NOR flash memory, a flash drive such as a solid state drive (SSD), a compact flash (CF) card, a secure digital (SD) card, a Micro-SD card, a Mini-SD card, an extreme digital (xD) card, or a memory stick, and/or a storage device such as a hard disk drive (HDD).

Under control of the controller 190 the power supply 160 may receive power from the outside of the communication robot 100 or from the inside of the communication robot 100, and may thus supply the received power to the constituent elements of the communication robot 100. The power supply 160 may include a battery. The battery may be implemented as an embedded battery or a replaceable battery, and may be chargeable using a wired or wireless charging method. Here, the wireless charging method of the battery may include a magnetic induction method or a magnetic resonance method. In the present embodiment, the battery may include a rechargeable secondary battery, for example, a nickel-cadmium battery, a lead battery, a nickel metal hydride (NiMH) battery, a lithium-ion battery, and a lithium polymer battery, but is not limited thereto.

In the present embodiment, the controller 190 may control charging or discharging of the battery, and may protect the battery by monitoring state information of the battery. For example, the controller 190 may perform various functions of the battery, for example, an overcharge protection function, an overdischarge protection function, an overcurrent protection function, an overvoltage protection function, an overheating protection function, and a cell balancing function of the battery. In addition, the controller 190 may acquire a current of the battery, a voltage of the battery, a temperature of the battery, a remaining power amount of the battery, a battery lifespan, and a state of charge (SOC) of the battery. For example, although not shown in the drawings, the controller 190 may measure a voltage and temperature of the battery using the sensor 130. If the sensor 130 detects the presence of an abnormal situation such as, for example, overcharging, overdischarging, overcurrent, or a high temperature in the battery, the controller 190 may protect the battery by controlling charging or discharging of the battery.

The mover 170 may include four wheels 171a to 171d, and may move or stop moving according to the operation mode and/or the operation state of the communication robot 100. The controller 190 may control the direction, movement, and/or stoppage of the four wheels 171a to 171d. Alternatively, the controller 190 may operate at least one of the four wheels 171a to 171d in response to a user gesture or user voice, so as to cause the communication robot 100 to move to an arbitrary place (for example, near the position of the user).

The processor 180 may search for one or more output devices 200 disposed in the same space as the communication robot 100, determine an operation mode of the communication robot 100, and adjust an output signal of the one or more output devices 200 in response to the operation mode of the communication robot 100. In addition, the processor 180 may select at least one of the one or more output devices 200 in response to the operation mode of the communication robot 100, may transmit at least one among an audio signal and a video signal to the selected output device 200, and may enable the output device 200 to output (reproduce) at least one among the audio signal and the video signal.

In the present embodiment, the processor 180 may include a searcher 181, a determiner 182, an adjuster 183, a calculator 184, and a selector 185. As shown in FIG. 4, the processor 180 may be located outside the controller 190, may be located in the controller 190, or may operate in the same manner as the controller 190. In addition, the processor 180 may also be included in the server 400 of FIG. 1.

The searcher 181 may be located in the same space as the communication robot 100, and may search for one or more output devices 200 that are operating. Here, being located in the same space as the communication robot 100 may refer to a state in which the one or more output devices 200 are arranged in an arbitrary space of the map based on which the communication robot may move, such that the output devices 200 may be connected to each other through a single network. For example, when the communication robot 100 is provided in a home, the output device 200 may be located, for example, in a living room, a kitchen, or a main room (bedroom) of the home in which the communication robot 100 can move.

Under control of the controller 190, in order to periodically confirm through the communicator 110 whether the one or more output devices 200 located in the vicinity of the communication robot 100 are activated, the searcher 181 may transmit an activation confirmation request signal to the one or more output devices 200. When the one or more output devices 200 that have received the activation confirmation request signal transmit an activation confirmation response signal to the searcher 181, the searcher 181 may receive the activation confirmation response signal and search for the output device 200.

Here, the output device 200 being activated may refer to a state in which the output device 200 is currently outputting at least one among an audio signal and a video signal, or a state in which, although not currently outputting an audio signal or a video signal, the output device 200 is connected to a power supply and is thus capable of outputting at least one among an audio signal and a video signal upon receiving a drive signal.

In addition, the activation confirmation response signal that is transferred from the outputter 200 to the searcher 181 may include, for example, type information and performance information of the output device 200. Information of the output device 200 corresponding to the activation confirmation response signal received by the searcher 181 may be stored in the storage 150 under control of the controller 190.

The determiner 182 may recognize and determine an operation mode of the communication robot 100. In the present embodiment, the determiner 182 may determine the operation mode of the communication robot 100 to be a call mode (voice call or video call) operating in conjunction with the user terminal 300, or may determine the operation mode of the communication robot 100 to be a content playback mode for requesting playback of content selected by the user. In the present embodiment, the call mode and the content playback mode may be included in an automatic mode in which the output volume may be automatically adjusted or selected. When the communication robot 100 is in the call mode, the display 141 may display information of the caller (such as an image, a name, and a phone number of the caller) under control of the controller 190, the audio outputter 142 may output the audio signal of the caller, and the microphone 122 may receive the audio signal of the user under control oldie controller 190. In addition, when the communication robot 100 is in the content playback mode, the display 141 may reproduce the video signal of the content under control of the controller 190, and the audio outputter 142 may output the audio signal of the content under control of the controller 190.

When the communication robot 100 is in the call mode or the content playback mode, the adjuster 183 may adjust the output signal of the searched one or more operating output devices 200 searched for by the searcher 100. Here, adjusting the output signal of the output device 200 may refer to adjusting the volume of the audio signal that is being outputted by the output device 200 to be lower than a current volume, adjusting the volume of the output audio signal to be turned off, or adjusting the volume of the output audio signal to be higher than the current volume. The reason for adjusting the output audio signal as described above is to prevent disturbance of a call being made or content being viewed by the user. The adjuster 183 consists of at least one of a adjuster or comprises at least one of a adjuster. The adjuster is configure to adjust the output signal of the searched one or more operating output devices 200 searched for by the searcher 100.

To this end, the storage 150 may store a control code (for example, a control code for adjusting volume) for controlling each output device 200. The adjuster 183 may transmit, to the output device 200, a control signal having the function of adjusting the output signal using the control code, and the output device 200 which receives the control signal may adjust the output volume of the audio signal.

The calculator 184 may calculate at least one among position information of the communication robot 100, position information of the output device 200, and position information of the user. The calculator 184 may construct a map using a Simultaneous Localization And Mapping (SLAM) algorithm, based on image information photographed by the camera 121 (for example, a stereo-vision camera or a Time of Flight (TOF) camera) and information sensed by the sensor 130, and may calculate the position information of the communication robot 100 and position information of an object (for example, the output device 200 and/or the user) within the constructed map. Since construction of a map using a SLAM algorithm and calculation of position information are well known to those skilled in the art, a detailed description thereof will be omitted in the following description. The calculator 184 comprises at least one of a calculator or consists of at least one of a calculator. The calculator is configure to calculate at least one among position information of the communication robot 100.

In the present embodiment, upon receiving the position information calculation result from the calculator 184 when the communication robot 100 is in the call mode or the content playback mode, the adjuster 183 may adjust an output volume of the audio signal being outputted by one output device 200 spaced apart from the communication robot 100 by a predetermined distance or less (for example, located within a network communication available range) from among the one or more operating output devices 200 searched for by the searcher 181, may adjust the output volume of the audio signal to be higher than a current volume, or may adjust the output volume of the audio signal to be turned off.

For example, assuming that music is being outputted by a two-channel speaker 220 acting as the output device 200 in a bedroom of the home, when the user and the communication robot 100 operating in the call mode or in the content playback mode enter the bedroom of the home, the adjuster 183 may adjust the volume of the audio signal (music) being outputted by the two-channel speaker 220 to be lower than a current volume, or may adjust the volume of the output audio signal to be turned off. In this case, the adjuster 183 may firstly select the function for adjusting an output volume to be lower than the current volume. Thereafter, the adjuster 183 may adjust the adjusted volume to be further reduced upon receiving a voice command of the user. In addition, when the adjuster 183 receives, a predetermined number of times (for example, at least five times), a voice command of the user desiring to further reduce the output volume, or when the adjuster 183 receives a voice command of the user desiring to turn off the two-channel speaker 220, the output volume may be turned off. In addition, when music is being outputted by the two-channel speaker 220 acting as the output device 200 in the bedroom of the home and the user and the communication robot 100 operating in the call mode or in the content playback mode enter the bedroom of the home, the adjuster 183 may adjust either the voice signal of the caller being outputted by the audio outputter 142 or the audio signal of the content being outputted by the audio outputter 142 to be higher than the output volume of the audio signal that is being outputted through the two-channel speaker 220.

When the communication robot 100 is in the call mode or in the content playback mode, the selector 185 may select one or more output devices 200 searched for by the searcher 181, and may transmit at least one among an audio signal and a video signal to the selected output device 200. In other words, the selector 185 may select one or more output devices 200 to be used to reproduce the video signal and/or the audio signal in the call mode or the content playback mode.

In general, during the communication mode, the communication robot 100 may display information of the caller (such as an image, a name, and a phone number of the caller) on the display 141, output an audio signal uttered by the caller to the audio outputter 142, and receive input of an audio signal uttered by the user (receiver) through the microphone 122.

However, when the communication robot 100 according to the present embodiment is operating in the call mode, the selector 185 may select the display 141 or any one of the output devices 200 (for example, a TV 210), and transmit the caller information (such as an image, a name, and a phone number of the caller) to the display 141 or any one of the output devices 200 (for example, the TV 210) such that the caller information can be displayed thereon. In addition, the selector 185 may select the audio outputter 142 or any one of the output devices 200 (for example, the two-channel speaker 220), transmit information of the audio signal uttered by the caller to the selected audio outputter 142 or the selected output device 200 (for example, the two-channel speaker 220) such that the audio signal information of the caller can be outputted by the selected audio outputter 142 or the selected output device 200. In addition, the selector 185 may select the microphone 122 or any one of the output devices 200 (such as the TV 210) having a microphone function, receive the audio signal of the user through the selected microphone 122 or any one of the output devices 200 (such as the TV 210) having the microphone function, and transmit the received audio signal to the caller.

In addition, generally, during the content playback mode, the communication robot 100 may output video signals of the content to the display 141, and may output audio signals of the content to the audio outputter 142.

However, when the communication robot 100 is operating in the content playback mode, the selector 185 may select the display 141 or any one of the output devices 200 (for example, the TV 210), and may transmit video information of the content to the selected display 141 or the selected output device 200 (for example, the TV 210) from among the output devices 200 such that the video information can be displayed thereon. In addition, the selector 185 may select the audio outputter 142 or any one of the output devices 200 (for example, the two-channel speaker 220), and may transmit audio information of the content to the selected audio outputter 142 or the selected output device 200 (for example, the two-channel speaker 220) such that the audio signal can be outputted by the selected audio outputter 142 or the selected output device 200.

In addition, when the communication robot 100 is operating in the content playback mode, the selector 185 may select, from among the output devices 200, one output device 200 which is appropriate to a type of the reproduced content. For example, when the content to be reproduced is a video signal, the selector 185 may select, from among the output devices 200, a high-performance output device 200 having a superior playback function of the video signal (for example, the TV 210 or beam projector 240), and transmit the video signal to the selected output device 200. When the content to be reproduced is an audio signal, the selector 185 may select, from among the output devices 200, a high-performance output device 200 having a superior playback function of the audio signal (for example, the two-channel speaker 220 or the AI speaker 230), and transmit the audio signal to the selected output device 200. Assuming that the content to be reproduced includes both a video signal and an audio signal, the selector 185 may select, from among the output devices 200, a high-performance output device 200 having a superior playback function of the video and audio signals (for example, the TV 210), and the selector 185 may transmit the video and audio signals to the selected output device 200.

In an alternative example of the present disclosure, the selector 185 may select one or more output devices 200 to be used to output at least one among a video signal and an audio signal according to priority information stored in the storage 150. For example, if the priority information related to the output of the audio signal and/or the video signal stored in the storage 150 is denoted by the order of TV 210→two-channel speaker 220→AI speaker 230→beam projector 240, the selector 185 may initially select the TV 210. The selector 185 comprises at least one of a selector or consists of at least one of a selector. The selector is configure to select the TV 210.

In an alternative example of the present disclosure, the selector 185 may select one output device 200 to be used to output at least one among the video signal and the audio signal according to performance information of the output device 200 stored in the storage 150. When the TV 210 and the two-channel speaker 220 are present as the output devices 200 located around the communication robot 100 when the display 141 of the communication robot 100 is outputting a video signal and the audio outputter 142 of the communication robot 100 is outputting an audio signal, the selector 185 may select the TV 210, which has a comparatively higher video playback performance, by comparing performance information of the TV 210 with performance information of the two-channel speaker 220, and the video signal may be transmitted to the TV 210 to be outputted thereby. In addition, the selector 185 may select the two-channel speaker 220, which has a comparatively higher audio playback performance, by comparing performance information of the TV 210 with performance information of the two-channel speaker 220, and the audio signal may be transmitted to the two-channel speaker 220 and outputted thereby.

In an alternative example of the present disclosure, the selector 185 may consider, as a composite whole (or according to the case, in part), position information of the communication robot 100, position information of the output device 200, position information of the user, and performance information of the output devices 200, and may thereby select one or more output devices 200. For example, when the two-channel speaker 220, as the output device 200 having superior performance information compared to the audio performance of the TV 210, is present in the vicinity of the communication robot 100 when the audio signal is being outputted to the TV 210 in response to a primary selection of the communication robot 100, the selector 185 may change the current selection to another selection so as to allow the two-channel speaker 220 to output the audio signal. In addition, when the communication robot 100 and the user are located in a specific region within a given space, the selector 185 may change the current selection to another selection so as to allow the TV 210, which is located close to the position of the user and which, as the output device 200, has the best video and/or audio performance, to output the audio signal.

The controller 190, as a kind of central processor (CPU), may control overall operation of the communication robot 100 by driving control software embedded in the storage 150. In the present embodiment, the controller 190 may search for one or more output devices 200 disposed in the same space as the communication robot 100, determine the operation mode of the communication robot 100, and adjust the output signal of the one or more searched output devices 200 in response to the operation mode of the communication robot 100. In addition, the controller 190 may select one or more of the output devices 200 in response to the operation mode of the communication robot 100, and may transmit at least one among an audio signal and a video signal to the selected output device 200 such that the output device 200 can output (reproduce) at least one among the audio signal and the video signal.

Here, the controller 190 may include all kinds of devices that are capable of processing data in the same manner as the processor. In this case, the processor may refer to a data processing device embedded in hardware, that has a physically structured circuit to perform at least one function composed of codes or commands included in a program. Although the above hardware-embedded data processing device may include various kinds of processors, for example, a microprocessor, a CPU, a processor core, a multiprocessor, an Application Specific Integrated Circuit (ASIC), and a field programmable gate array (FPGA), the present disclosure is not limited thereto.

In the present embodiment, the communication robot 100 may search for the output device 200, adjust the volume of the audio signal outputted by the output device 200, and perform machine learning, such as deep learning, in response to the selection result of the output device 200. The storage 150 may store, for example, data and resultant data used for machine learning.

Deep learning is one kind of machine learning, and may allow a device or apparatus to perform learning in multiple, progressively deeper stages based on data. Deep learning may represent a set or aggregate of machine learning algorithms that are capable of extracting important data from a plurality of data sets in proportion to the increasing learning level.

A deep learning structure may include an artificial neural network (ANN). For example, the deep learning structure may include a deep neural network (DNN), such as a convolutional neural network (CNN), a recurrent neural network (RNN), and a deep belief network (DBN). In the present embodiment, the deep learning structure may use a variety of structures well known to those skilled in the art. For example, the deep learning structure according to the present disclosure may include a CNN, a RNN, and a DBN. The RNN has been widely used in natural language processing, and can be effectively used to process time-series data that changes over time, and may construct an ANN structure by progressively extracting higher level features through multiple layers. The DBN may include a deep learning structure that is constructed by stacking the result of restricted Boltzman machine (RBM) learning in multiple layers. When a predetermined number of layers are constructed by repetition of such RBM learning, the DBN provided with the predetermined number of layers can be constructed. The CNN may include a specific model constructed by modeling of a brain function. The specific model assumes that basic characteristics of a target object are extracted when the person recognizes the target object, and the extracted result is then processed by a complex calculation such that the target object can be recognized.

Further, the ANN learning can be achieved by adjusting a weight value of a node-to-node connection line such that a desired output value in response to a given input value is acquired. If necessary, the ANN learning can also be achieved by adjusting a bias value of the node-to-node connection line. In addition, the ANN can continuously update the weight value through learning. In addition, a method such as, for example, back propagation may be applied to such ANN learning.

The communication robot 100 may be provided with an ANN. In order to search for one or more output devices 200 disposed in the same space as the communication robot 100 and which are outputting at least one among an audio signal and a video signal, and to adjust the output signal of the one or more searched output devices 200 in response to the operation mode of the communication robot 100, the communication robot 100 may perform the searching for the output device 200 and the adjusting of the output signal based on machine learning. In addition, in order to select at least one among the one or more searched output devices 200 in response to the operation mode of the communication robot 100, and transmit at least one among the audio signal and the video signal to the selected output device 200, the communication robot 100 may perform the selecting of the output device 200 and the transmitting of the signals based on machine learning.

The controller 190 may include an artificial neural network (ANN), for example, a deep neural network (DNN) such as a CNN, an RNN, or a DBN, and perform learning of the DNN. Machine learning paradigms, in which the ANN operates, may include unsupervised learning and supervised learning. In response to setting information, the controller 190 may update a tone recognition ANN structure after execution of learning.

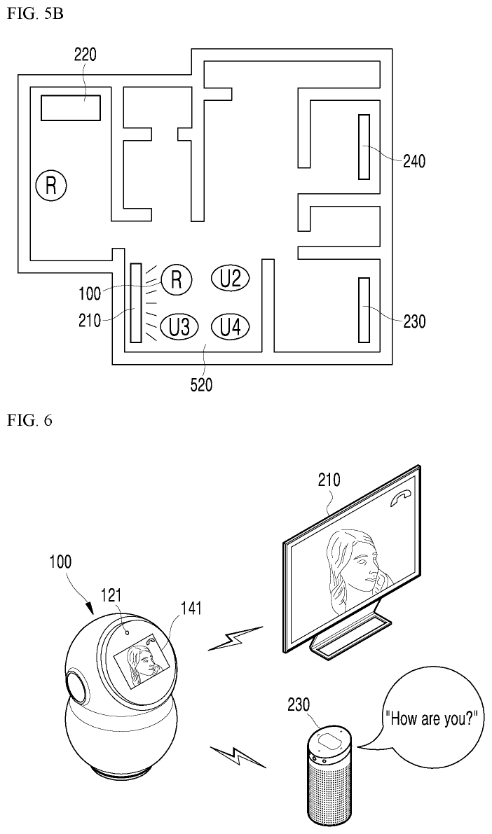

FIG. 5 is a conceptual diagram illustrating a method for driving the communication robot 100 according to an embodiment of the present disclosure. In the following description, description of reference numerals overlapping with those of FIGS. 1 to 4 will be omitted for convenience of description.

Referring to FIG. 5A, in a first space 510 (for example, a bedroom), the two-channel speaker 220 acting as the output device 200 is outputting music, a first user U1 (for example, a baby) is sleeping in the bedroom, a second user U2 (for example, one parent of the baby) has entered the first space 510 in order to check on the state of the first user U1, and the communication robot 100 has followed the second user U2 into the first space 510. In this case, the communication robot 100 may, when in the call mode, perform a call between the second user U2 and a caller. Alternatively, when in the content playback mode, the communication robot 100 may reproduce content selected by the second user U2. The communication robot 100, having entered the first space 510, may recognize an activation state of the two-channel speaker 220 through searching, and may transmit, to the two-channel speaker 220, a control signal for adjusting the output volume, such that the volume of the music being outputted by the two-channel speaker 220 is adjusted to be lower than a current volume, or the voice signal of the caller or the audio signal of the content that is being outputted by the audio outputter 142 is adjusted to be lower than the current volume. The reason for performing the above-mentioned adjustment operations is to prevent the first user, who is sleeping in the first space 510, from being woken up.

Here, since the storage 150 may store characteristic information related to the baby acting as the first user and characteristic information related to the parent acting as the second user, the communication robot 100 may identify each user based on the information stored in the storage 150, and may determine that the first user is sleeping by recognizing a facial image of the first user through the camera 121. In addition, the storage 150 may pre-store a control signal which may cause the output volume of the audio signal of the output device 200 to be adjusted to the lowest volume when the first user is identified.

Referring to FIG. 5B, in a second space 520 (for example, a living room), the TV 210 acting as the output device 200 is outputting the video and audio signals, a third user U3 (for example, one family member) and a fourth user U4 (for example, another family member) are watching the TV 210, the second user U2 has moved from the first space 510 to the second space 520, and the communication robot 100 has followed the second user U2 into the second space 520. In this case, the communication robot 100 may, when in the call mode, perform a call between the second user and a caller. Alternatively, when in the content playback mode, the communication robot 100 may reproduce content selected by the second user. The communication robot 100, having entered the second space 520, may adjust an output volume of the audio signal being outputted by the TV 210 to be lower than a current volume, or may adjust the voice signal of the caller or the audio signal of the content being outputted by the audio outputter 142 to be higher than the volume of the output signal of the TV 210. The reason for performing the above-mentioned adjustment operations is to allow the second user U2, having moved to the second space 520, to easily make a call or to easily view the content.

FIG. 6 is a conceptual diagram illustrating a method for driving the communication robot 100 according to an embodiment of the present disclosure. In the following description, description of reference numerals overlapping with those of FIGS. 1 to 4 will be omitted for convenience of description.

Referring to FIG. 6, the communication robot 100 is operating in a video call mode, caller information (for example, an image, name, and phone number of the caller) is being displayed on the display 141, and the voice of the caller is being outputted by the audio outputter 142 (not shown). The communication robot 100 may select the TV 210 from among the output devices 200 according to predefined priority information, the result of a distance calculation, or the result of a performance comparison, and may transmit the caller information to the TV 210 so as to display the caller information on the TV 210. In addition, the communication robot 100 may select the AI speaker 230 from among the output devices 200, and may transmit the voice of the caller to the AI speaker 230 so that the AI speaker 230 can output the voice of the caller.

In the present embodiment, the communication robot 100 may maintain its original state (that is, a state of displaying the caller information through the display 141 and a state of outputting the voice of the caller through the audio outputter 142), while at the same time transmitting the voice of the caller to the AI speaker 230.

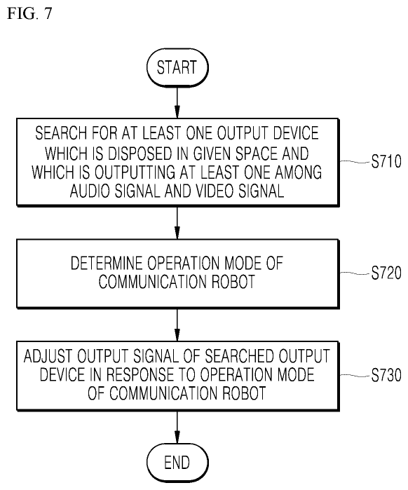

FIG. 7 is a conceptual diagram illustrating a method for driving the communication robot 100 according to an embodiment of the present disclosure. In the following description, description of reference numerals overlapping with those of FIGS. 1 to 6 will be omitted for convenience of description.

Referring to FIG. 7, in step S710, the communication robot 100 is located in a given space (for example, a home, an office, or a hospital), and the communication robot 100 may search for one or more output devices 200 that are disposed in the same space as the communication robot 100 and that are outputting at least one among an audio signal and a video signal. When the communication robot 100 periodically transmits, through the network 500, an activation confirmation request signal for determining whether one or more output devices 200 located around the communication robot 100 are activated, and when one or more output devices 200 that have received the activation confirmation request signal transmit an activation confirmation response signal to the communication robot 100, the communication robot 100 may search for the output device 200 upon receiving the activation confirmation response signal. Here, the output device 200 being activated may refer to a state in which the output device 200 is currently outputting at least one among an audio signal and a video signal, or a state in which, although not currently outputting an audio signal or a video signal, the output device 200 is connected to a power supply and is thus capable of outputting at least one among an audio signal and a video signal upon receiving a drive signal.

In step S720, the communication robot 100 may determine its operation mode. The operation mode of the communication robot 100 may include a call mode (voice call or video call) operating in conjunction with the user terminal 300, and a content playback mode for requesting playback of user-selected content. When the communication robot 100 is in the call mode, the display 141 may display the caller information (for example, an image, name, and phone number of the caller) under control of the controller 190, the audio outputter 142 may output the audio signal of the caller, and the microphone 122 may receive the audio signal of the user. In addition, when the communication robot 100 is in the content playback mode, the display 141 may reproduce the video signal of the content under control of the controller 190, and the audio outputter 142 may output the audio signal of the content.

In step S730, the communication robot 100 may adjust the output signal of the searched output device in response to the operation mode determined in step S720. In this case, the adjustment of the output signal of the output device 200 may include adjusting an output volume of the audio signal being outputted from the output device 200 to be lower than a current volume, adjusting an output volume of the audio signal to be turned off, and adjusting an output volume of the audio signal to be higher than a current volume.

In an alternative example of the present disclosure, the communication robot 100 may calculate at least one among position information of the communication robot 100, position information of the output device 200, and position information of the user, and among the one or more searched output devices 200 may adjust the output volume of the audio signal being outputted by the output device 200 that is spaced apart from the communication robot 100 by a predetermined distance or less (for example, located within a network communication available range) to be lower than a current volume, may adjust the output volume of the audio signal to be higher than a current volume, or may adjust the output volume of the audio signal to be turned off.

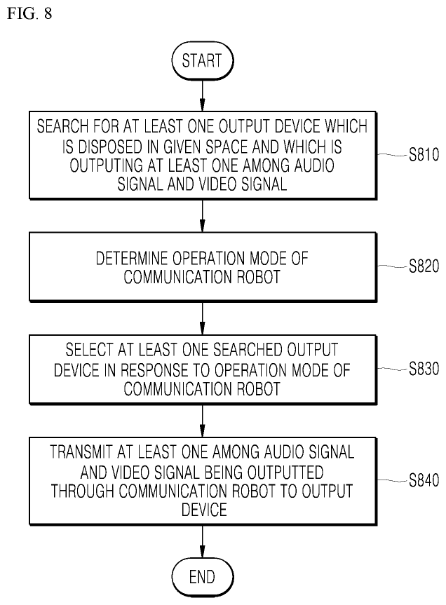

FIG. 8 is a flowchart illustrating a method for driving the communication robot 100 according to another embodiment of the present disclosure. In the following description, description of reference numerals overlapping with those of FIGS. 1 to 7 will be omitted for convenience of description.

Referring to FIG. 8, in step S810, the communication robot 100 is located in a given space (for example, a home, an office, or a hospital), and may search for one or more output devices 200 that are disposed in the same space as the communication robot 100 and that are outputting at least one among an audio signal and a video signal.

In step S820, the communication robot 100 may determine its operation mode. The operation mode of the communication robot 100 may include a call mode (voice call video call) made in conjunction with the user terminal 300, and a content playback mode for requesting playback of user-selected content.

In step S830, the communication robot 100 may select at least one of the one or more searched output devices 200 in response to the operation mode determined in step S820. In this case, the selecting of the output device 200 may include, during a call mode in which a call between the user and the caller is being made through the display (141 in FIG. 4) and the audio outputter (142 in FIG. 4) of the communication robot 100, selecting any one output device 200 to be used to output caller information (a video signal indicating, for example, an image, name, and phone number of the caller), selecting any one output device 200 to be used to output the voice of the caller, or selecting any one output device 200 to be used to output the caller information and the voice of the caller. In addition, the selecting of the output device 200 may include, during the content playback mode in which user-selected content is reproduced by the display (141 in FIG. 4) and the audio outputter (142 in FIG. 4) of the communication robot 100, selecting any one output device 200 to be used to output the video signal contained in the content, selecting any one output device 200 to be used to output the audio signal contained in the content, and selecting any one output device 200 to be used to output the video signal and the audio signal contained in the content.

The communication robot 100 may select one or more output devices 200 to be used to output at least one among the video signal and the audio signal according to pre-stored priority information, or may select one output device 200 having superior performance information based on the result of a comparison between pre-stored performance information of the output devices 200. In an alternative example of the present disclosure, the communication robot 100 may calculate at least one among position information of the communication robot 100, position information of the output device 200, and position information of the user, and may select one output device 200 spaced apart from the communication robot 100 by a predetermined distance or less (for example, located within a network communication available range) from among the one or more searched output devices 200 that are operating.

In step S840, the communication robot 100 may transmit at least one among the audio signal and the video signal to the selected output device 200.

The above-mentioned embodiments of the present disclosure may be implemented as a computer program executable in computer(s) through various constituent elements. The above-mentioned computer program may be recorded in a computer readable medium. Examples of the computer readable medium may include magnetic media such as a hard disk drives (HDD), floppy disks and a magnetic tapes, optical media such as CD-ROMs and DVDs, magneto-optical media such as floptical disks, or hardware devices such as ROMs, RAMS, and flash memories specifically configured to store and execute program commands.

In addition, the above computer programs may be specially designed and configured for the present disclosure, or may be known to those skilled in the field of computer software. Examples of computer programs may include machine language codes such as codes generated by a compiler high-level language codes executable by a computer using an interpreter.

In the present application (especially, in the appended claims), the use of the terms “the”, “the above-mentioned”, and/or other terms similar thereto may correspond to singular meaning, plural meaning, or both of the singular meaning and the plural meaning as necessary. In addition, the term “range” disclosed in the present disclosure may include the scope of the invention to which individual values belonging to the above range are applied (unless otherwise stated in the context), and may also include the resultant values obtained when the individual values belonging to the above range are written in the detailed description of the present disclosure.

The above-mentioned steps constructing the method disclosed in the present disclosure may be performed in a proper order unless explicitly stated otherwise. However, the scope or spirit of the present disclosure is not limited thereto. In the present disclosure, all examples or all exemplary terms (“for example”, “such as”) have been disclosed only for illustrative purposes of the present disclosure for convenience of description, and the present disclosure is not limited thereto. In addition, technical ideas of the present disclosure can also be readily implemented by those skilled in the art according to various conditions and factors within the scope of the appended claims to which various modifications, combinations, and changes are added, or equivalents thereof. Therefore, technical ideas of the present disclosure are not limited to the above-mentioned embodiments, and it is intended that not only the appended claims, but also all changes equivalent to the claims, should be considered to fall within the scope of the present disclosure.

What is claimed is:

1. A method for controlling a communication robot disposed in a given space, comprising:
searching for one or more output devices which are disposed in the space and which are outputting at least one among an audio signal and a video signal; and
adjusting an output signal of the searched output device in response to an operation mode of the communication robot.

2. The method according to claim 1, further comprising:
after completion of the searching for the one or more output devices, calculating at least one among position information of the communication robot and position information of the output device.

3. The method according to claim 2, wherein the adjusting the output signal of the searched output device includes adjusting an output signal of the output device that is spaced apart from the communication robot by a predetermined distance or less.

4. The method according to claim 1, further comprising:
after completion of the searching for the one or more output devices, selecting at least one of the one or more searched output devices in response to an operation mode of the communication robot; and
transmitting, to the selected output device, at least one among an audio signal and a video signal that are being outputted by the communication robot.

5. The method according to claim 4, wherein the selecting the at least one of the one or more searched output devices includes selecting an output device corresponding to predefined priority information from among the one or more searched output devices, in response to the operation mode of the communication robot.

6. The method according to claim 4, wherein the selecting the at least one of the one or more searched output devices includes selecting an output device from among the one or more searched output devices based on performance information, in response to the operation mode of the communication robot.

7. The method according to claim 6, wherein the performance information includes:
in case of an audio signal, at least one among output intensity information, information about the number of channels, and specific output function information; and
in case of a video signal, at least one among resolution information, size information of the output device, and specific output function information.

8. The method according to claim 1, wherein the adjusting the output signal of the output device includes reducing an output volume of the output device in response to a call mode of the communication robot.

9. The method according to claim 4, wherein the selecting the output device corresponding to predefined priority information includes selecting an output device appropriate to a type of content to be reproduced, in response to a content playback mode of the communication robot.

10. A computer program stored in a computer-readable recording medium, configured to perform a method disclosed in claim 1 using a computer.

11. A communication robot disposed in a given space, comprising:
a searcher configured to search for one or more output devices which are disposed in the space and which are outputting at least one among an audio signal and a video signal; and
an adjuster configured to adjust an output signal of the searched output device in response to an operation mode of the communication robot.

12. The communication robot according to claim 11, further comprising a calculator configured to calculate at least one among position information of the communication robot and position information of the output device, after completion of the searching by the searcher.

13. The communication robot according to claim 12, wherein the adjuster adjusts an output signal of the output device that is spaced apart from the communication robot by a predetermined distance or less.

14. The communication robot according to claim 11, further comprising a selector configured to, after completion of the searching by the searcher, select at least one of the one or more searched output devices in response to an operation mode of the communication robot, and transmit, to the selected output device, at least one among an audio signal and a video signal that are being outputted by the communication robot.

15. The communication robot according to claim 14, wherein the selector selects an output device from among the one or more searched output devices corresponding to predefined priority information, in response to the operation mode of the communication robot.

16. The communication robot according to claim 14, wherein the selector selects an output device from among the one or more searched output devices based on performance information, in response to the operation mode of the communication robot.

17. The communication robot according to claim 16, wherein the performance information includes:
in case of an audio signal, at least one among output intensity information, information about the number of channels, and specific output function information; and
in case of a video signal, at least one among resolution information, size information of the output device, and specific output function information.

18. The communication robot according to claim 11, wherein the adjuster reduces an output volume of the output device in response to a call mode of the communication robot.

19. The communication robot according to claim 14, wherein the selector selects an output device appropriate for a type of content to be reproduced, in response to a content playback mode of the communication robot.
